(19) United States
(12) Patent Application Publication
(10) Pub. No.: US 2008/0001515 A1
(43) Pub. Date: Jan. 3, 2008

(54) FLUORESCENT COMPLEX AND LIGHTING SYSTEM USING THE SAME

(75) Inventors: Hiroki Iwanaga, Yokohama-shi (JP); Akio Amano, Kawasaki-shi (JP); Fumihiko Aiga, Yokohama-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (JP)

(21) Appl. No.: 11/678,999

(22) Filed: Feb. 26, 2007

(30) Foreign Application Priority Data
Jul. 3, 2006 (JP) 2006-183088

(51) Int. Cl. H01J 1/62; C07F 5/00

(52) U.S. Cl. 313/483; 534/16

(57) ABSTRACT

This invention provides a fluorescent complex possessing excellent durability and luminous intensity, and a lighting system utilizing the same. The fluorescent complex comprises a rare earth ion and a β-diketone ligand. In the fluorescent complex, the β-diketone ligand comprises a β-diketone skeleton, a fluoroalkyl group, and an electron donative linking group for linking the β-diketone skeleton to the fluoroalkyl group. The fluorescent complex can be utilized in a lighting system. The rare earth ion is preferably a lanthanoid ion, particularly preferably a europium or terbium ion. When the β-diketone ligand further comprises an aromatic group, the luminous intensity can be further improved.

### CROSS-REFERENCE TO RELATED APPLICATIONS

This application is based upon and claims the benefit of priority from the prior Japanese Patent Application No. 183088/2006, filed on Jul. 3, 2006; the entire contents of which are incorporated herein by reference.

### BACKGROUND OF THE INVENTION

1. Field of the Invention

The present invention relates to a fluorescent complex and a lighting system possessing a high level of luminosity and a prolonged service life.

2. Background Art

In recent years, the luminosity and service life of LED elements have been significantly improved, and a wide range market development including illumination applications is under way.

LED elements using inorganic fluorescent substances, which are currently commonly used, are being significantly improved in luminescence efficiency. In particular, regarding white LEDs, it is said that the luminescence efficiency will exceed the luminescence efficiency of fluorescent lamps in the future. When LEDs are used in lighting systems, however, in many cases, these lighting systems are used in applications where not only excellent luminescence efficiency but also excellent color rendering properties are required. At the present time, LEDs using only inorganic fluorescent substances cannot simultaneously satisfy all of these properties without difficulties.

The concept that organic fluorescent substances are used in LEDs is already known. At the present time, however, LEDs using organic fluorescent substances as the fluorescent substance have not been put to practical use in illumination applications due to the presence of the following problems.

1) In particular, when near ultraviolet LEDs, which are currently being mainly adopted, are used as a light source and organic fluorescent substances are used in LEDs using luminescent materials for R, G, and B, a deterioration in organic compounds by ultraviolet light is significant, because organic compounds are generally weak against ultraviolet light.

2) Since organic fluorescent substances sometimes cause a variation in a fluorescence spectrum depending upon its concentration, the regulation of the spectrum is difficult. Further, the fluorescence intensity depends upon the concentration, and, thus, concentration quenching disadvantageously takes place in a high concentration region.

3) The fluorescence spectrum sometimes disadvantageously varies depending upon the type of polymer dispersed in the organic fluorescent substance.

In general, the fluorescent substance formed of a rare earth complex has the following advantages over conventional organic fluorescent substances.

1) The luminescence wavelength is characteristic of rare earthes and thus is less likely to be influenced by the coloring matter concentration and the type of polymer to be dispersed, and, thus, the fluorescence spectrum is stable.

2) Although the ligand is an organic compound, upon the excitation of the ligand through the absorption of light, the state is returned to the ground state by energy transfer to the central element. Accordingly, the opportunity for causing an irreversible chemical change from the excited state is reduced, and, thus, durability against ultraviolet light can be expected.

However, further luminous intensity and prolonged service life are required for the development of general illumination market. Stability of a ligand per se against a photochemical reaction may be mentioned as properties that significantly affect durability. Fluorescent substances to be irradiated in LEDs are exposed to severe conditions, that is, strong heat and light and thus are likely to undergo a radical (oxidative) deterioration. When the ligand is chemically changed, the coordinative ability is lowered and the ligand is broken. As a result, in some cases, the fluorescence intensity is deteriorated, and the chemically changed ligand is causative of deactivation.

On the other hand, the introduction of a fluorine-containing group into the ligand of a rare earth complex has also been proposed from the viewpoint of increasing the luminous intensity. For example, Japanese Patent Laid-Open No. 26969/2003 and Japanese Patent Laid-Open No. 173622/2002 disclose ultraviolet excitation-type ink compositions. Although these publications do not relate to lighting systems such as LEDs, a fluorescent complex comprising a fluoroalkyl group directly bonded to a β-diketone skeleton is disclosed. According to studies conducted by the present inventors, it was found that the introduction of the fluorine-containing group results in deteriorated durability of the fluorescent complex. That is, there is a trade-off relationship between luminous intensity and service life, and the development of a fluorescent complex, which can simultaneously satisfy luminous intensity and service life requirements, has been desired.

Further, in order to realize a high level of luminous intensity in a lighting system using a fluorescent complex, a high level of solubility or dispersibility of the fluorescent complex in the resin is required. When the solubility or dispersibility is small and the fluorescent substance is present as particles in the resin, satisfactory luminous intensity cannot be provided due to light scattering.

Furthermore, the structure of the polymer capable of dissolving the rare earth complex greatly affects the luminous intensity of the LED element. Specifically, in the case of rare earth complexes, particularly europium complexes, when a C—H or O—H bond is present near the ion, vibrational deactivation occurs disadvantageously resulting in quenching. Specifically, when a C—H or O—H bond is present in the polymer for dissolution, disadvantageously, there is a tendency toward attenuation of the fluorescence intensity. In the polymer, however, it is practically impossible to eliminate all the above bonds. Accordingly, measures should be taken for preventing a reduction in luminous intensity by the influence of the polymer.

### BRIEF SUMMARY OF THE INVENTION

Under the above circumstances, the present invention has been made, and an object of the present invention is to realize a lighting system that can withstand lighting system applications and has high level of luminous intensity and service life.

The present inventions have made extensive and intensive studies with a view to attaining the above object and, as a result, have found that a high level of luminous intensity and a high level of durability can be realized when a fluorescent complex with a specific ligand introduced thereinto is used, which has led to the completion of the present invention. Specifically, according to the present invention, there is provided a fluorescent complex comprising a rare earth ion and a β-diketone ligand, wherein said β-diketone ligand comprises a β-diketone skeleton, a fluoroalkyl group, and an electron donative linking group for linking the β-diketone skeleton to the fluoroalkyl group.

Further, according to the present invention, there is also provided a lighting system comprising a light emitting element having a light emitting face and a fluorescent layer disposed on or above the light emitting element on the side of the light emitting face, the fluorescent layer comprising the above fluorescent complex.

Furthermore, according to the present invention, there are provided a camera and a cellular phone with a camera, the camera comprising a lighting system, the lightingsystem comprising a light emitting element having a light emitting face and a fluorescent layer disposed on or above the light emitting element on the side of the light emitting face, the fluorescent layer comprising the above fluorescent complex.

The fluorescent complex according to the present invention realizes a high level of luminous intensity by virtue of the fluoroalkyl group bonded to the β-diketone ligand and, at the same time, can realize excellent durability by virtue of the effect of the linking group linking the fluoroalkyl group to the β-diketone ligand. In particular, the fluorescent complex according to the present invention containing europium as the rare earth ion can realize a red LED element having a large spectral intensity in the red region and further can realize a high-luminous intensity white LED element utilizing this element. When a fluorescent complex, which simultaneously has excellent luminous intensity and durability, is used, the production of highly practicable lighting systems, cameras comprising them and the like can be realized.

### BRIEF DESCRIPTION OF THE DRAWINGS

FIG. 1 is a cross-sectional view of a near ultraviolet red LED element in one embodiment of the present invention;

FIG. 2 is a cross-sectional view of a white LED element in one embodiment of the present invention;

FIG. 3 is a conceptual diagram of a camera comprising a flashing device using a fluorescent complex in one embodiment of the present invention; and

FIG. 4 is a conceptual diagram of a cellular phone with a camera, the camera comprising a flashing device using a fluorescent complex in one embodiment of the present invention.

### DETAILED DESCRIPTION OF THE INVENTION

The fluorescent complex according to the present invention comprises a rare earth ion and a β-diketone ligand. The rare earth ion can be properly selected so that fluorescence with a wavelength depending upon applications is emitted. However, preferred are lanthanoid ions. More specifically, europium or terbium is preferred. Europium is particularly preferred from the viewpoint of realizing a fluorescent complex having a large spectral intensity in the red region and excellent color rendering properties.

Further, the fluorescent complex according to the present invention has a β-diketone ligand. A fluoroalkyl group is bonded to this β-diketone ligand through an electron donative linking group.

The fluoroalkyl group refers to an alkyl group in which hydrogen has been substituted by fluorine. The luminous intensity increases with increasing the degree of substitution by fluorine. Accordingly, a fluoroalkyl group in which not less than 50% of the alkyl group has been substituted by fluorine is preferred, and a fluoroalkyl group in which all the hydrogen atoms in the alkyl group have been entirely substituted by fluorine, that is, a perfluoroalkyl group, is most preferred. The number of carbon atoms in the fluoroalkyl group is not particularly limited. In general, however, the number of carbon atoms is 1 to 22, preferably 3 to 7. The fluoroalkyl group may be of a straight chain type or a branched chain type.

It is considered that, in the fluorescent complex according to the present invention, the luminous intensity is increased by activating the C—H bond in the β-diketone ligand by taking advantage of an electron withdrawing property of the fluoroalkyl group. When the fluoroalkyl group is bonded directly to the β-diketone ligand, however, the durability of the complex is likely to be lowered. The present invention has succeeded in simultaneously realizing excellent luminous intensity and durability by introducing an electron donative linking group into between the β-diketone skeleton and the fluoroalkyl group.

In the present invention, the linking group for linking the β-diketone ligand skeleton to the fluoroalkyl group is used for keeping the fluoroalkyl group as the electron withdrawing group away from the β-diketone skeleton. To this end, the linking group should be electron donative. This linking group is selected from the group consisting of hydrocarbon chains, siloxane bond, ether bond, thioether bond, and seleno bond. Said hydrocarbon chain can contain unsaturated bond, and may be straight chain or branched chain. Among them, hydrocarbon chains, particularly alkylene groups, are preferred from the viewpoint of easiness on synthesis. The length of the electron donative group is not particularly limited. In the case of the alkylene group, however, the number of carbon atoms is 1 to 22, preferably 1 to 7.

This linking group is generally bonded to the β-diketone ligand skeleton at its 1-position and/or 3-position. Hydrogen is generally bonded to the β-diketone skeleton at its 2-position. Alternatively, deuterium or fluorine may be bonded.

The fluorescent complex according to the present invention may contain an aromatic substituent. When the aromatic substituent is bonded to the β-diketone ligand skeleton at its 1-position or 3-position, the luminous intensity of the fluorescent complex is advantageously increased. The aromatic substituent is not particularly limited so far as the substituent has an aromatic ring. Examples of aromatic substituents include phenyl, biphenyl, naphthyl, and fluorenyl groups. They may be substituted, for example, by an alkyl or alkoxy group. Among them, the fluorenyl group is preferred because luminous intensity increasing effect is large.

A preferred structure of the fluorescent complex may be represented as follows:

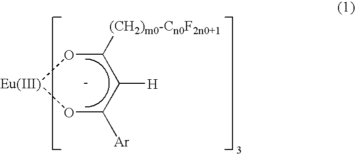

wherein m0 and n0 are an integer of 1 or more, preferably m0 is 1 to 22 and n0 is 1 to 22; and Ar represents a substituted or unsubstituted aromatic group.

The fluorescent complex according to the present invention may contain other ligand different from the β-diketone ligand. When such ligands are used, the distortion of the ligand field occurs and the luminous intensity is further increased. Such ligands include phosphine oxide and sulfonylamide. More specifically, ligands having the following structures are preferred.

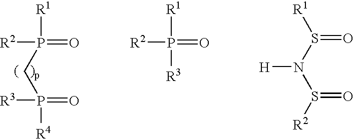

wherein R¹ to R⁴, which may be the same or different, represent a group selected from the group consisting of alkyl, substituted alkyl, alkoxy, substituted alkoxy, phenyl, substituted phenyl, biphenyl, substituted biphenyl, naphthyl, and substituted naphthyl; and p is an integer of 1 to 7.

Among the fluorescent complexes having ligands other than the β-diketone ligand, fluorescent complexes represented by formulae (2) to (4) may be mentioned as preferred examples.

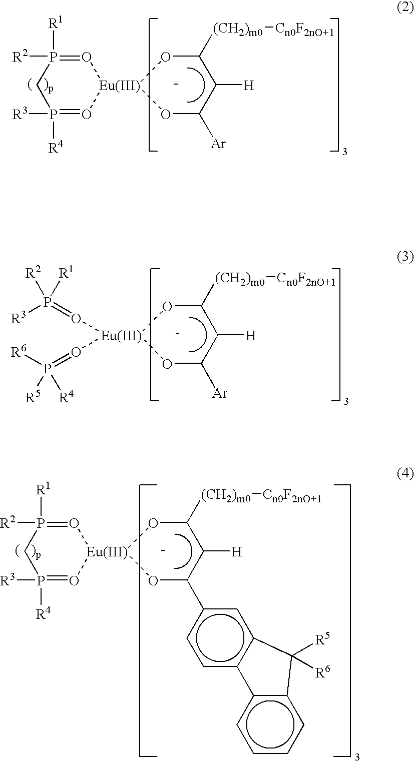

wherein, m0 and n0 are an integer of 1 or more; Ar represents a substituted or unsubstituted aromatic group; R¹ to R⁶, which may be the same or different, represent a group selected from the group consisting of alkyl, substituted alkyl, alkoxy, substituted alkoxy, phenyl, substituted phenyl, biphenyl, substituted biphenyl, naphthyl, and substituted naphthyl; and p is an integer of 1 to 7.

Further, in the fluorescent complex according to the present invention, crown ether ligands or cyclic multidentate ligands may be used as other ligands. Such cyclic ligands are preferred because they can significantly attain fluorescent complex ligand field distortion effect and can significantly increase the luminous intensity. Such cyclic ligands include cyclic multidentate ligands as described in Japanese Patent Application No. 180421/2005. This type of ligands have the following structure.

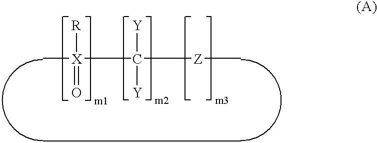

wherein:

X represents an atom selected from the group consisting of phosphorus, sulfur, and carbon, and, when a plurality of X's are present in the molecule, they may be the same or different,

R represents a substituent selected from the group consisting of a substituted or unsubstituted straight chain or branched chain alkyl having 20 or less carbon atoms, alkoxy having 20 or less carbon atoms, phenyl, biphenyl, naphthyl and a heterocyclic group, and substituted groups thereof when X bonded to R is a phosphorous atom; R is absent when X bonded to R is a carbon atom; R is absent or represents oxygen bonded to a sulfur atom through a double bond when X bonded to R is the sulfur atom; and when a plurality of R's are present in the molecule, they may be the same or different,

Y represents hydrogen or an alkyl or alkoxy group having 20 or less carbon atoms; Y's in the molecule may be the same or different; and Y may be bonded to another Y in the molecule through a carbon chain optionally containing oxygen to form a crosslinked ring structure,

Z represents a divalent group selected from the group consisting of —O—, —NY^{a}—, —S—, and —Se— wherein Y^{a} represents a substituent selected from the group consisting of a substituted or unsubstituted straight chain or branched chain alkyl having 20 or less carbon atoms, alkoxy having 20 or less carbon atoms, phenyl, biphenyl, naphthyl and a heterocyclic group, and substituted groups thereof; Y^{a} may be bonded to another Y or Y^{a} in the molecule through a carbon chain optionally containing oxygen to form a crosslinked ring structure; and when a plurality of Z's are present in the molecule, they may be the same or different;

m1 and m3 are independently an integer including 0 (zero),

m1+m3 is 2 or more, and

m2 is an integer of m1+m3 or more, and wherein:

—X(═O)R—, —CY₂—, and —Z— in the formula are arranged randomly and are bonded to one another in a ring form.

The fluorescent complex according to the present invention may be prepared by allowing the rare earth ion-containing salt, for example, chloride, nitrate, or hydroxide, to react with the ligand in a solvent if necessary with heating. For example, water, alcohols, and ester solvents are generally used as the solvent.

The fluorescent complex according to the present invention absorbs light and emits light with a longer wavelength than the absorbed light. When this property is utilized, a combination of the fluorescent complex with a light emitting element which emits light by taking advantage of electric energy or the like can realize the emission of light with a wavelength different from light emitted from the light emitting element. Further, a combination of the fluorescent complex, for example, with a YAG fluorescent substance or a coloring matter can provide a light emitting element having excellent color rendering properties.

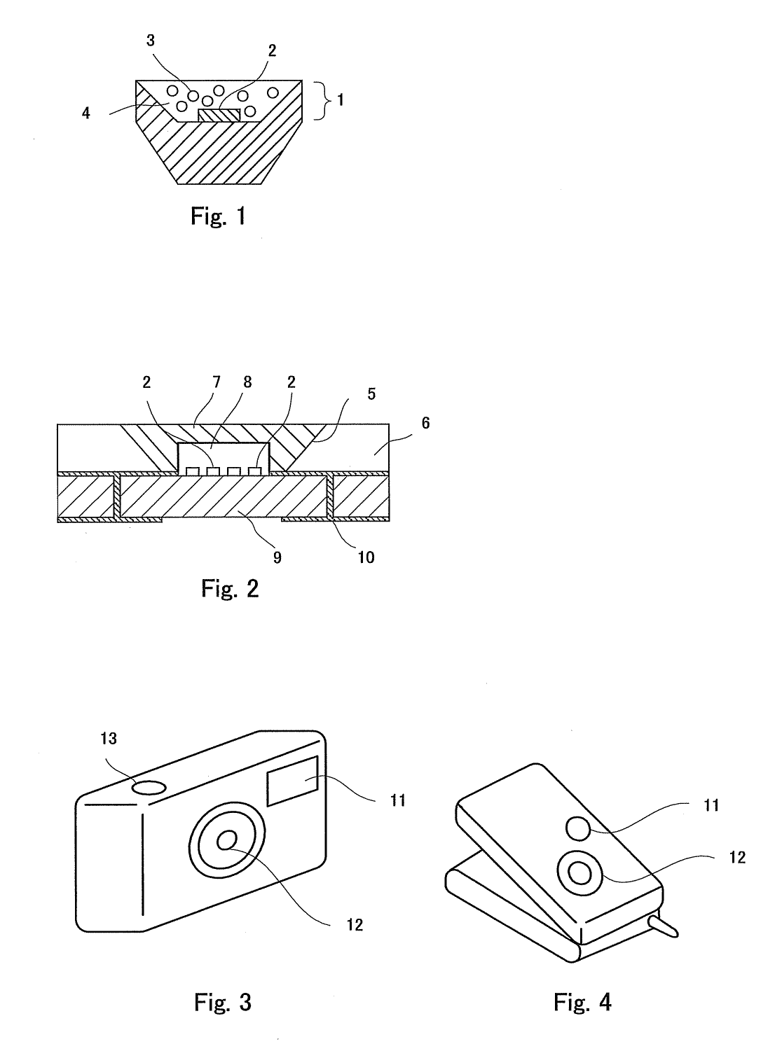

One example of this light emitting element is a near ultraviolet red LED element, and FIG. 1 is a cross-sectional view of the light emitting element. An LED chip 2 is provided on a storage vessel 1. A fluorescent layer 1 comprising a fluorescent complex 3 according to the present invention dispersed in a matrix polymer 4 is disposed on the LED chip 2. According to this construction, upon exposure to light emitted form LED, the fluorescent complex emits light. Further, other fluorescent layer may be combined to prepare white LED. FIG. 2 is a cross-sectional view of this light emitting element. In the white LED element, an LED chip 2 emits light upon the supply of electric energy from an electrode 10 provided on a substrate 9. The fluorescent layer is disposed in a space defined by a casing 6 provided on the substrate and a reflecting plate 5 provided on the surface thereof. Upon absorption of light emitted from the LED chip 2, the fluorescent complex contained in a first fluorescent layer 8 emits light with a wavelength different from the absorbed light. Further, the fluorescent complex contained in a second fluorescent layer 7, which has absorbed light emitted from the LED chip and/or light emitted from the first fluorescent layer, emits light with a wavelength different from the absorbed light. Thus, light emitted from the LED chip and light emitted from the fluorescent layers are radiated from the light emitting element.

In this light emitting element, a fluororesin is preferably used as a resin constituting the fluorescent layer. This is because the content of the C—H and O—H bonds in the resin is low. Accordingly, resins having a high fluorination degree are more preferred. However, the fluororesin may be properly selected depending, for example, upon the solubility or dispersibility of the fluorescent complex and other components used. Resins usable herein include Cefral Coat FG700X, A402B, and A610X manufactured by Central Glass Co., Ltd., LUMIFLON manufactured by Asahi Glass Co., Ltd., ZEONOR manufactured by Zeon Corporation, KYNAR, KYNAR FLEX manufactured by Atofina Japan, DUFLON manufactured by Nippon Paint Co., Ltd., and Dyneon THV220, 310, and 415 manufactured by Sumitomo 3M Ltd. (all the above products being tradenames). In addition to the fluorescent complex according to the present invention, for example, YAG fluorescent substances, alkaline earth metal silicate fluorescent substances, alkaline earth metal phosphate fluorescent substances, halophosphate fluorescent substances, BAM:Eu,Mn, BAM:Eu,ZnS, SrGa₂S₄:Eu, oxynitride:Eu, SrAlO4:Eu, alkaline earth apatite:Eu, Ca apatite:Eu,Mn, CaS:Ce, Y₂SiO₅:Tb, Sr₂P₂O₇:Eu,Mn, and SrAl₂O₄:Eu may also be used in the fluorescent layer. Further, white luminescence can also be realized by combining some of them.

The above light emitting element as such may be used in a lighting system and further may be applied to a flashlight device utilizing a short luminescence life. In particular, the light emitting element according to the present invention utilizes elements having small electric energy consumption such as LEDs and thus is useful as a flashlight device for cellular phones with a camera. In such applications, the flashlight device can be used in the same manner as in other conventional light emitting elements. FIGS. 3 and 4 are conceptual diagrams of a camera and a cellular phone with a camera comprising a light emitting element using the fluorescent complex according to one embodiment of the present invention as a flashlight device.

The camera and the cellular phone with a camera each comprise a flashlight device 11, a lens 12, and a shutter button 13 (not shown in FIG. 4). The construction of the camera and the cellular phone with a camera is the same as that of the conventional camera and cellular phone with a camera, except that the light emitting element according to the present invention is used as the flashlight device 11. The light emitting element according to the present invention possesses excellent color rendering properties and long service life and thus is suitable for use in these camera and cellular phone with a camera.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

### EXAMPLES

Although the following Examples further illustrate the present invention, the present invention is not restricted by these Examples.

### Synthesis Example

Europium complexes according to the present invention can be synthesized by any desired method, for example, through a synthetic route shown in FIG. 1 or synthetic routes to which the synthetic route shown as follwows has been applied.

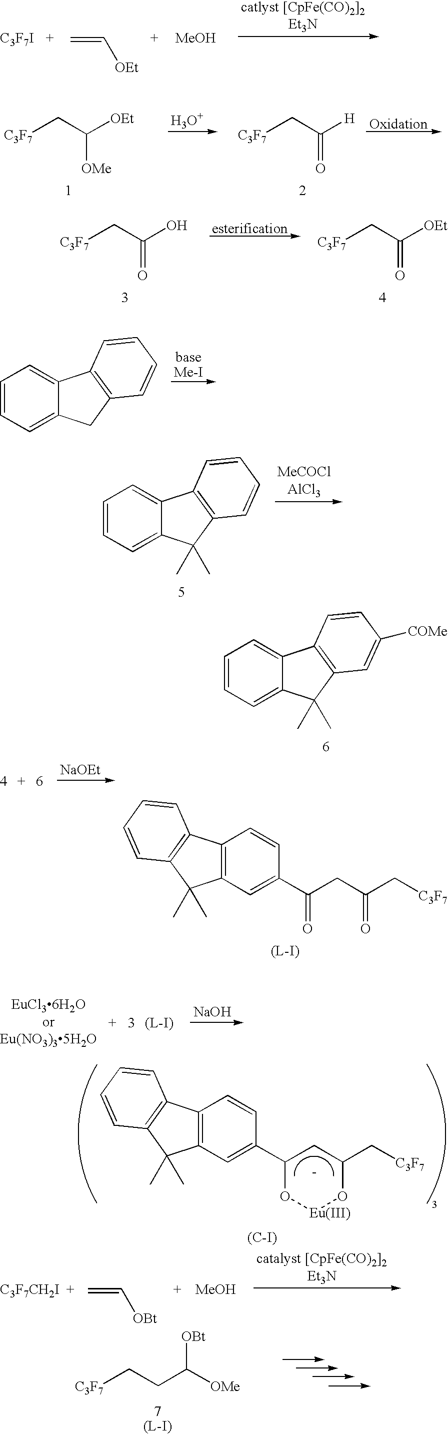

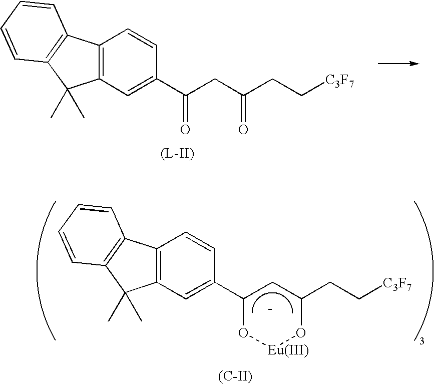

### Example 1

10% by weight of a compound represented by formula (5) was dissolved in a xylene solution of Cefral Coat FG700X (tradename) manufactured by Central Glass Co., Ltd. The solvent was completely removed, and a near ultraviolet excitation (395 nm) red LED element shown in FIG. 1 was then prepared. The initial luminous flux of this LED element was measured. Next, a high-temperature, high-humidity test was carried out under conditions of temperature 85° C. and humidity 85% for 62 hr. After the test, the luminous flux was measured and was compared with the initial measured value. As a result, a luminous flux reduction was not observed.

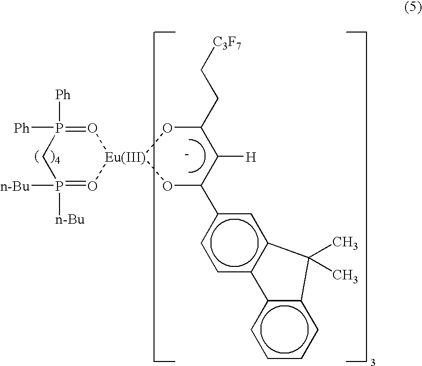

### Example 2

An LED element was prepared in quite the same manner as in Example 1, except that a europium complex represented by formula (6) was used. The LED element thus prepared was tested. The retention of the luminous flux after the high-temperature, high-humidity test relative to the initial luminous flux was good and 95%.

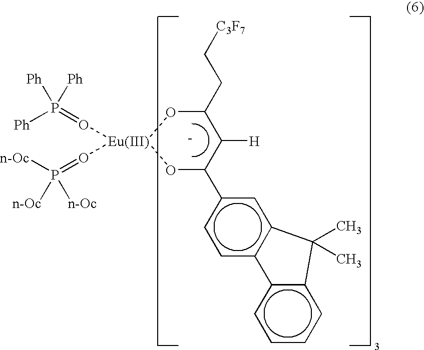

### Example 3

An LED element was prepared in quite the same manner as in Example 1, except that a europium complex represented by formula (7) was used. The LED element thus prepared was tested. The retention of the luminous flux after the high-temperature, high-humidity test relative to the initial luminous flux was good and 80%.

The luminous flux reduction is seemed to be derived from that, due to the absence of the phosphine oxide ligand, a part of the polymer component is coordinated to europium and vibrational deactivation occurred.

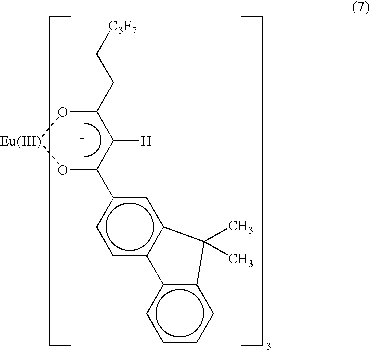

### Example 4

10% by weight of a compound represented by formula (8) was dissolved in a xylene solution of Cefral Coat FG700X (tradename) manufactured by Central Glass Co., Ltd. The solvent was completely removed, and a near ultraviolet excitation (395 nm) red LED element shown in FIG. 1 was then prepared. The initial luminous flux of this LED element was measured. Next, a high-temperature, high-humidity test was carried out under conditions of temperature 85° C. and humidity 85% for 100 hr. After the test, the luminous flux was measured and was compared with the initial measured value. As a result, a luminous flux reduction was not observed.

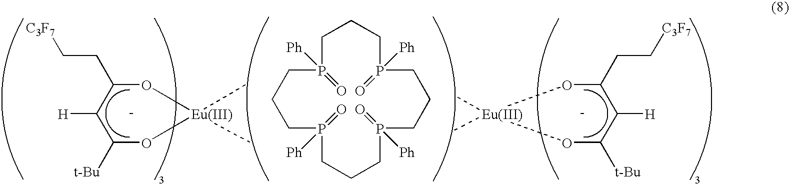

### Example 5

An LED element was prepared in quite the same manner as in Example 4, except that a europium complex represented by formula (9) was used. The initial luminous flux of this LED element was measured. Next, a high-temperature, high-humidity test was carried out under conditions of temperature 85° C. and humidity 85% for 100 hr. After the test, the luminous flux was measured and was compared with the initial measured value. As a result, a luminous flux reduction was not observed.

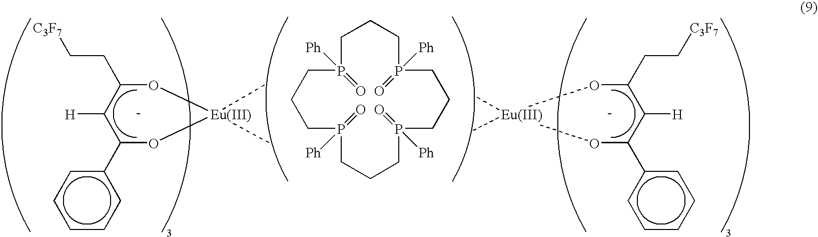

### Comparative Example 1

An LED element was prepared in quite the same manner as in Example 1, except that a europium complex represented by formula (10) was used. The LED element thus prepared was tested. The retention of the luminous flux after the high-temperature, high-humidity test relative to the initial luminous flux was 20%, that is, it was found that there was a large deterioration in luminous flux.

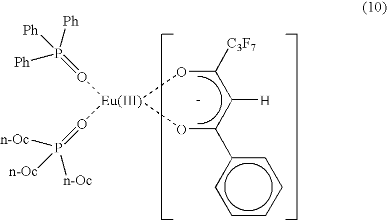

### Example 6

A white LED element was prepared by using the fluorescent layer in Example 1 as a second fluorescent layer in a white LED element shown in FIG. 2. The white LED element did not cause a deterioration in luminous flux after the high-temperature, high-humidity test relative to the initial luminous flux. Further, there was no europium complex-derived attenuation of the spectral intensity with the central wavelength being 615 nm. For a first yellow fluorescent layer, 30% by weight of an alkaline earth metal silicate luminescent material was used.

1. A fluorescent complex comprising a rare earth ion and a β-diketone ligand, wherein said β-diketone ligand comprises a β-diketone skeleton, a fluoroalkyl group, and an electron donative linking group for linking the β-diketone skeleton to the fluoroalkyl group.

2. The fluorescent complex according to claim 1, wherein said rare earth ion is a lanthanoid ion.

3. The fluorescent complex according to claim 2, wherein said lanthanoid ion is a europium or terbium ion.

4. The fluorescent complex according to claim 1, wherein said linking group is selected from the group consisting of hydrocarbon chains, siloxane bond, ether bond, thioether bond, and seleno bond.

5. The fluorescent complex according to claim 1, wherein said β-diketone ligand further comprises an aromatic substituent.

6. The fluorescent complex according to claim 1, which has a structure represented by formula (1): 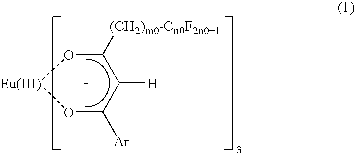
wherein m0 and n0 are an integer of 1 or more; and Ar represents a substituted or unsubstituted aromatic group.

7. The fluorescent complex according to claim 1, wherein a phosphine oxide ligand is further coordinated to the rare earth ion.

8. The fluorescent complex according to claim 7, which has any of structures represented by formulae (2) to (4): 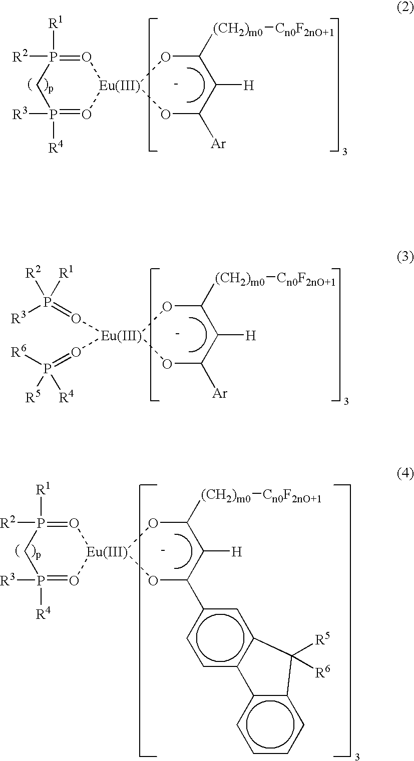
wherein, m0 and n0 are an integer of 1 or more; Ar represents a substituted or unsubstituted aromatic group; R¹ to R⁶, which may be the same or different, represent a group selected from the group consisting of alkyl, substituted alkyl, alkoxy, substituted alkoxy, phenyl, substituted phenyl, biphenyl, substituted biphenyl, naphthyl, and substituted naphthyl groups; and p is an integer of 1 to 7.

9. The fluorescent complex according to claim 1, wherein a cyclic multidentate ligand having a structure comprising a plurality of coordinating groups bonded to one another in a ring form is further coordinated to the rare earth ion.

10. The fluorescent complex according to claim 9, wherein said cyclic multidentate ligand has a structure of formula (A): 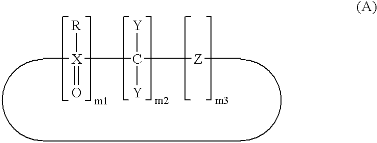
wherein:
X represents an atom selected from the group consisting of phosphorus, sulfur, and carbon, and, when a plurality of X's are present in the molecule, they may be the same or different,
R represents a substituent selected from the group consisting of alkyl group having 20 or less carbon atoms, alkoxy group having 20 or less carbon atoms, phenyl, biphenyl, naphthyl and a heterocyclic group, and substituted groups thereof when X bonded to R is a phosphorous atom; R is absent when X bonded to R is a carbon atom; R is absent or represents oxygen bonded to a sulfur atom through a double bond when X bonded to R is the sulfur atom; and when a plurality of R's are present in the molecule, they may be the same or different,
Y represents hydrogen or an alkyl or alkoxy group having 20 or less carbon atoms; Y's in the molecule may be the same or different and Y may be bonded to another Y in the molecule through a carbon chain optionally containing oxygen to form a crosslinked ring structure,
Z represents a divalent group selected from the group consisting of —O—, —NY^{a}—, —S—, and —Se— wherein Y^{a} represents a substituent selected from the group consisting of alkyl having 20 or less carbon atoms, alkoxy having 20 or less carbon atoms, phenyl, biphenyl, naphthyl and a heterocyclic group, and substituted groups thereof; Y^{a} may be bonded to another Y or Y^{a} in the molecule through a carbon chain optionally containing oxygen to form a crosslinked ring structure; and when a plurality of Z's are present in the molecule, they may be the same or different;
m1 and m3 are independently an integer including 0 (zero),
m1+m3 is 2 or more,
m2 is an integer of m1+m3 or more, and wherein;
—X(═O)R—, —CY₂—, and —Z— in the formula are arranged randomly and are bonded to one another in a ring form.

11. A lighting system comprising a light emitting element having a light emitting face and a fluorescent layer disposed on or above the light emitting element on the side of the light emitting face, the fluorescent layer comprising the fluorescent complex according to claim 1.

12. A camera comprising as a flashlight device a lighting system, the lighting system comprising a light emitting element having a light emitting face and a fluorescent layer disposed on or above the light emitting element on the side of the light emitting face, the fluorescent layer comprising the fluorescent complex according to claim 1.

13. A cellular phone with a camera, the camera comprising as a flashlight device a lighting system, the lighting system comprising a light emitting element having a light emitting face and a fluorescent layer disposed on or above the light emitting element on the side of the light emitting face, the fluorescent layer comprising the fluorescent complex according to claim 1.
